(19) United States
(12) Patent Application Publication
(10) Pub. No.: US 2026/0237260 A1
(43) Pub. Date: Aug. 13, 2026

(54) SYSTEM AND METHOD FOR LIMITING SCREEN TIME ON ELECTRONIC DEVICES

(71) Applicant: Scott Frederick Harvey, Sonoma, CA (US)

(72) Inventor: Scott Frederick Harvey, Sonoma, CA (US)

(73) Assignee: ScreenZen LLC, Sonoma, CA (US)

(21) Appl. No.: 19/540,528

(22) Filed: Feb. 13, 2026

Related U.S. Application Data
(60) Provisional application No. 63/758,033, filed on Feb. 13, 2025.

(51) Int. Cl. G07C 9/00; H04W 12/08

(52) U.S. Cl. CPC G07C 9/00309; H04W 12/08

(57) ABSTRACT

Described herein is an electronic device screen-time limiting system comprising a mobile application having a locking module, an unlocking module, a communication module, a temporary access module, and a data analytics and feedback module; a short-range wireless communication device in electronic communication with the mobile application wherein the locking module can prevent access to an electronic device based on a specific time of the day, exceeding a usage threshold, or failing to connect the short-range wireless communication device to the mobile application, wherein the unlocking module can grant access to the electronic device based on an expiration of a timer, the specific time of the day, or by connecting the short-range wireless communication device to the mobile application and wherein the communication module is configured to communicate with one or more short-range wireless communication devices to provide data to the mobile application relating to locking or unlocking the electronic device.

### CROSS-REFERENCE TO PRIOR APPLICATION

The present application claims priority and benefit of U.S. Provisional Patent Application No. 63/758,033, filed on Feb. 13, 2025, which application is incorporated by reference to the extent permitted by applicable law.

### FIELD OF THE INVENTION

The present invention relates to a system for limiting screen time on electronic devices, and more particularly, to a mobile application and physical key for limiting screen time on electronic devices.

### BACKGROUND OF THE INVENTION

In recent years, the widespread adoption of electronic devices such as smartphones, tablets, and computers has led to concerns regarding excessive screen time and its associated negative effects on users' health and well-being. Prolonged exposure to digital screens has been linked to issues such as eye strain, sleep disruption, reduced productivity, and behavioral problems, particularly among children and adolescents. While various parental control applications and built-in device settings allow users to impose screen time limits, these existing solutions often rely on manual enforcement, are easily bypassed by tech-savvy users, or lack the flexibility needed to adapt to different usage contexts. Accordingly, there remains a need for an improved system for regulating screen time that provides an effective, adaptable, and tamper-resistant approach to limiting excessive device use.

However, traditional approaches rely on static time-based restrictions. These approaches are rigid and do not tailor specifically to each user. Therefore, a user-specific system that is low-cost and effective for everyday use is desired.

### SUMMARY OF THE INVENTION

The present invention provides an electronic device screen-time limiting system including a mobile application executable on an electronic device and a physical key configured to be in electronic communication with a communication module of the mobile application when the physical key is within a short-range wireless communication range of the electronic device. In some embodiments, the mobile application includes a locking module, an unlocking module, and a communication module; and wherein the mobile application is configured to transition the electronic device between a locked state, and an unlocked state. In some embodiments, the locking module is configured to transition the electronic device into the locked state upon satisfaction of one or more locking criteria, and wherein the locked state implements one or more locking restrictions including restricted access to one or more applications, websites, and device functions. In some embodiments, the locking module is further configured to operate in a settings-lock mode, wherein the settings-lock mode prevents modification of the one or more locking criteria, the one or more locking restrictions, and the one or more unlocking criteria. In some embodiments, the settings-lock mode is activated upon engagement of the physical key with the communication module. In some embodiments, while the settings-lock mode is active, the one or more locking criteria and the one or more locking restrictions remain immutable regardless of user input attempting to modify them. In some embodiments, modification of the one or more locking criteria and the one or more locking restrictions is permitted only upon re-engagement of the physical key with the communication module to deactivate the settings-lock mode. In some embodiments, the unlocking module is configured to grant access to the electronic device based on satisfaction of one or more unlocking criteria, and wherein the unlocking module is configured to grant access to the electronic device upon engagement of the physical key with the communication module when the electronic device is in the locked state.

In some embodiments, the one or more locking criteria are selected from the group consisting of: time of day, exceeding a usage threshold, and physical location of the electronic device.

In some embodiments, the locking module includes an access restriction module and a settings lock module, wherein the settings lock module prevents modification of the one or more locking criteria and the one or more locking restrictions, and wherein the access restriction module and the settings lock module operate independently such that the electronic device transitions between a fully locked state, a partially locked state, a partially unlocked state, and a fully unlocked state.

In some embodiments, the electronic device screen-time limiting system further includes a compliance monitoring mechanism configured to detect if the electronic device is in a compliant state or a noncompliant state, wherein the compliance monitoring mechanism is configured to cause the electronic device to periodically transmit a compliance heartbeat to a remote server, the compliance heartbeat including data selected from the group consisting of: active enforcement data, operating system permission data, and timestamp data; wherein the noncompliant state is determined when required operating system permissions are disabled or a compliance heartbeat has not been received for at least a threshold time interval; and wherein upon determining the noncompliant state, the compliance monitoring mechanism performs at least one of the following actions: transmits an alert to a designated contact, conditions physical key authorization on compliance restoration, and triggers a financial penalty.

In some embodiments, the locking module prevents modification of the locking criteria unless authorized by engagement of the physical key in a settings unlock mode.

In an alternate embodiment, an electronic device screen-time limiting system includes a mobile application executable on one or more electronic devices and a physical key configured to be in electronic communication with the communication module of the mobile application when the physical key is within a short-range wireless communication range of one of the one or more electronic devices. In some embodiments, the mobile application includes an access restriction module, a settings lock module, an access unlock module, a settings unlock module, and a communication module, and wherein the mobile application is configured to transition the one or more electronic devices between a fully locked state, a partially locked state, a partially unlocked state, and a fully unlocked state. In some embodiments, the access restriction module is configured to implement one or more locking restrictions for the one or more electronic devices based on the satisfaction of one or more locking criteria, wherein the one or more locking restrictions define access limitations for mobile applications, websites, and electronic device functions. In some embodiments, the one or more electronic devices are in the partially locked state when the access restriction module is active and wherein when in the partially locked state the one or more electronic devices may have restricted access to device functions but are able to reconfigure the one or more locking restrictions and the one or more locking criteria. In some embodiments, the settings lock module is configured to prevent modification of the one or more locking restrictions, the one or more locking criteria, and the one or more unlocking criteria based on engagement of the physical key with the communication module. In some embodiments, the one or more electronic devices are in the fully locked state when the access restriction module and settings lock module are active, and wherein when in the fully locked state, the one or more electronic devices have restricted access to device functions and are unable to reconfigure the one or more locking restrictions and the one or more locking criteria. In some embodiments, the access unlock module is configured to grant access to the one or more electronic devices based on satisfaction of one or more unlocking criteria. In some embodiments, the one or more electronic devices are in the partially unlocked state when the access unlock module is active and the settings lock module is active, wherein when in partially unlocked state, the one or more electronic devices have access to device functions but are unable to reconfigure the one or more locking restrictions and the one or more locking criteria. In some embodiments, the settings unlock module is configured to permit modification of the one or more locking restrictions upon re-engagement of the physical key with the communication module. In some embodiments, the one or more electronic devices are in the fully unlocked state when the access unlock module is active and the settings unlock module is active, wherein when in fully unlocked state, the one or more electronic devices have access to device functions and are able to reconfigure the one or more locking restrictions and the one or more locking criteria.

In some embodiments, the one or more locking criteria are selected from the group consisting of a time-based criterion that prevents access at a specified time of day, a threshold-based criterion that prevents access when a usage threshold is exceeded, a location-based criterion that prevents access when the electronic device is within a restricted area, and a schedule-based criterion that prevents access according to a defined schedule.

In some embodiments, the one or more unlocking criteria are selected from the group consisting of an expiration of a timer, a specified time of day, a location-based criterion that grants access when the electronic device is located within a permitted area, and engagement of the physical key with the communication module.

In some embodiments, the electronic device screen-time limiting system further includes a temporary access module configured to override the access restriction module to provide time-limited access to the mobile applications, websites, and device functions when the one or more electronic devices are in the fully locked state. In some embodiments, the temporary access module does not override the settings lock module. In some embodiments, the temporary access module is activated upon at least one of: entry of a specified emergency code and engagement of the physical key with the communication module.

In some embodiments, the electronic device screen-time limiting system further includes a compliance monitoring mechanism configured to detect if the electronic device is in a compliant state or a noncompliant state, wherein the compliance monitoring mechanism is configured to cause the electronic device to periodically transmit a compliance heartbeat to a remote server, the compliance heartbeat including data selected from the group consisting of: active enforcement data, operating system permission data, and timestamp data; wherein the noncompliant state is determined when required operating system permissions are disabled or a compliance heartbeat has not been received for at least a threshold time interval; and wherein upon determining the noncompliant state, the compliance monitoring mechanism performs at least one of the following actions: transmits an alert to a designated contact, conditions physical key authorization on compliance restoration, and triggers a financial penalty.

In a further embodiment an electronic device screen-time limiting system includes a mobile application executable on an electronic device, and a physical key configured to communicate with the communication module when the physical key is in short-range wireless communication with the electronic device. In some embodiments, the mobile application includes a locking module and a communication module. In some embodiments, the locking module is configured to track usage of the electronic device. In some embodiments, the locking module is configured to determine when a usage threshold is satisfied and transition the electronic device into a post-limit state upon satisfaction of the usage threshold. In some embodiments, in the post-limit state, the locking module implements one or more locking restrictions that prevent access to one or more applications, websites, or device functions. In some embodiments, when in the post-limit state, the locking module maintains the one or more locking restrictions unless an authorization signal is received from the physical key. In some embodiments, upon receipt of the authorization signal from the physical key, the mobile application grants a bounded overage budget comprising at least one of additional usage time, a number of application launches, and a number of unlock events, wherein the bounded overage budget is available during an overage window. In some embodiments, the mobile application is configured to monitor usage of the electronic device relative to the bounded overage budget as usage occurs during the overage window. In some embodiments, the locking module re-implements the one or more locking restrictions when the bounded overage budget is exhausted or the overage window expires.

In some embodiments, the physical key communicates parameterization data to the mobile application at a time of authorization, the parameterization data specifying at least one of an overage amount and a duration of the overage window, and wherein the bounded overage budget is determined based on the parameterization data received from the physical key.

In some embodiments, the physical key comprises a knob or dial having a plurality of discrete positions each corresponding to a different lock duration, and wherein engagement of the physical key causes the mobile application to enforce the locked state for the lock duration corresponding to a selected position.

In some embodiments, the mobile application is further executable on a plurality of electronic devices and further includes an unlocking module and a synchronization module. In some embodiments, the plurality of electronic devices are communicatively coupled through a shared network. In some embodiments, the synchronization module is configured to propagate the post-limit state to all of the plurality of electronic devices via the shared network.

In some embodiments, the unlocking module on each of the plurality of electronic devices is configured to grant access based on satisfaction of one or more unlocking criteria, and wherein satisfaction of the one or more unlocking criteria on any one of the plurality of electronic devices propagates an unlocked state to all other electronic devices connected to the shared network.

In some embodiments, engagement of the physical key with a first electronic device propagates an unlocked state to all of the devices within the plurality of electronic devices connected to the shared network.

In some embodiments, the synchronization module is configured to selectively propagate the post-limit state to a subset of the plurality of electronic devices based on device type or user-defined groupings.

In some embodiments, the synchronization module is configured to propagate the post-limit state to any electronic devices within the plurality of electronic devices that lack short-range wireless communication capability.

In some embodiments, the synchronization module includes a local unlock mode, wherein the local unlock mode requires engagement of a physical key with one of the plurality of electronic devices, and upon engagement, the engaged electronic device unlocks without propagating the unlocked state to other devices.

In some embodiments, the usage threshold and bounded overage budget are associated with a group policy profile comprising an owner role and one or more member roles, wherein only an electronic device associated with the owner role is authorized to configure the usage threshold and bounded overage budget parameters and to authorize granting of the bounded overage budget via the physical key, and wherein electronic devices associated with the one or more member roles cannot modify these parameters or authorize overage.

### BRIEF DESCRIPTION OF THE DRAWINGS

The features of the exemplary embodiments of the present invention will be described with reference to the following drawings, where like elements are labeled similarly, and in which:

FIG. 1 is a schematic diagram of a first embodiment of a screen-time limiting system according to the present disclosure;

FIG. 2 is a schematic diagram of the mobile application of the present disclosure;

FIG. 3 is a state diagram of the transition of locked and unlocked state of an electronic device having the screen-time limiting system active on the device according to the present disclosure;

FIG. 4 is a schematic diagram of a locking criteria of the present disclosure;

FIG. 5 is a schematic diagram of an unlocking criteria of the present disclosure;

FIG. 6 is a schematic diagram of a second embodiment of the screen-time limiting system according to the present disclosure;

FIG. 7 is a flow diagram of the transition of the one or more electronic devices from a fully unlocked state to a fully locked state, according to the present disclosure; and

FIG. 8 is a flow diagram of a user's interaction with the screen-time limiting system according to the present disclosure.

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION OF THE EMBODIMENTS

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

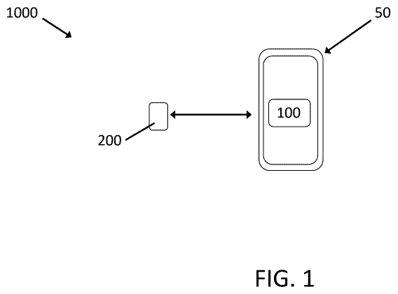

FIG. 1 depicts an exemplary embodiment of an electronic device screen-time limiting system having a mobile application and a physical key. The present disclosure imposes user-driven friction rather than rigid usage limiters of electronic devices such that a user can have a customized system and method for reducing and/or limiting their usage of screen time for electronic devices. This design encourages mindful usage with short bursts of allowed time, thereby preventing lengthy distraction spirals. The present disclosure implements not only software-related friction points for the user, such as electronic locks to prevent access, but also physical friction points for the user including communication with a physical key 200 such as a Near-Field Communication (NFC) device, stand, fob, or tag, all of which would require a user to perform a deliberate action to regain access to the electronic device, thereby creating another friction point that allows the user to reconsider their use of the electronic device when encountering a friction point. Some examples of friction points implemented by the system of the present disclosure include daily usage thresholds, physical key communications, user feedback messages, specific daily schedules for allowed usage, location-based device locking, and an individual settings lock to prevent unwanted bypass of the restrictions.

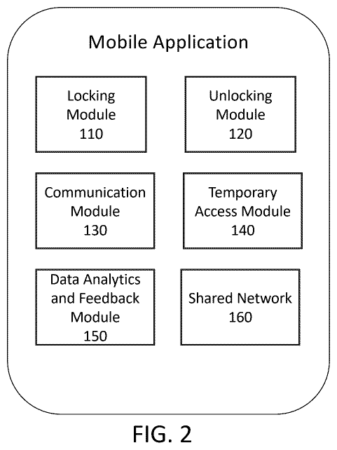

As shown in FIG. 1, the electronic device screen-time limiting system 1000 includes a mobile application 100 and a physical key 200, each of which communicate with one or more electronic devices 50, such as a smartphone, tablet, laptop computer, desktop computer, gaming console, and the like. In some embodiments, as shown for example in FIG. 2, the mobile application 100 includes one or more modules that each provide specific functions to create unique friction points for the user to minimize and prevent distracted usage of the electronic device 50. For example, in some embodiments, the mobile application 100 includes a locking module 110 and an unlocking module 120. In some embodiments, the mobile application 100 further includes a communication module 130 for communicating with the physical key 200. In some embodiments, the mobile application 100 further includes a temporary access module 140 for providing a short period of access to the user's electronic device 50, thereby bypassing any existing restrictions on the device. In some embodiments, the mobile application 100 further includes a data analytics and feedback module 150 for providing analytics, messages, and feedback to a user, such as motivational messages to encourage positive trends, progress reports to a user that further describe their recent usage trends, and frictional messages which help prevent unwanted usage of the electronic device 50. As shown in FIG. 2, the mobile application 100 uses a combination of modules 110, 120, 130, 140, and 150 to limit usage, provide access, create friction, and provide feedback to the user, wherein each of the modules' usage and selected mode is determined based on current and past trends from the user along with any additional requirements selected by the user. Therefore, the system 1000 not only provides multiple forms of friction to limit and prevent unwanted use but also customizes the restrictions based on the user's performance, including their adherence to the restrictions, previous trends, streaks, and goals, along with their desired outcome.

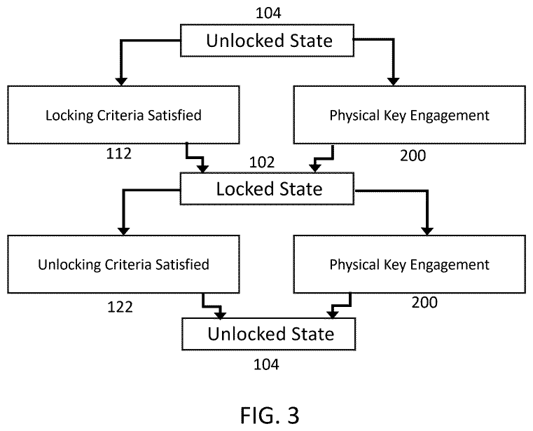

As shown for example in FIG. 3, the mobile application 100 is configured to transition the electronic device 50 between a locked state 102 and an unlocked state 104. In some embodiments, the physical key 200 operates as a toggle mechanism based on the current state of the electronic device 50. When the electronic device 50 is in the unlocked state 104, engagement of the physical key 200 with the communication module 130 causes the locking module 110 to activate and transition the device 50 to the locked state 102. Conversely, when the electronic device 50 is in the locked state 102, engagement of the physical key 200 with the communication module 130 causes the unlocking module 120 to activate and transition the device 50 to the unlocked state 104. This toggle mechanism provides a simple and intuitive physical friction point that requires deliberate user action to change the device state.

The locking module 110 prevents the electronic device 50 from being used at a given time or under specified conditions. In some embodiments, the locking module 110 prevents any use of the electronic device 50 while the device is in the locked state 102. In other embodiments, the locking module 110 prevents selected uses of the electronic device 50 while the device is in the locked state 102. For example, the locking module 110 may prevent a user from engaging with one or more features of the electronic device 50, such as mobile applications, specific websites, or device functions (e.g., camera or text messages) while allowing a user to engage with other features of the electronic device 50, such as placing phone calls.

In some embodiments, the user may select which features, or restrictions, will be locked or prevented access to while the electronic device 50 is in the locked state 102. In some embodiments, the mobile application 100 automatically configures which features are prevented access to, based on a plurality of factors including previous usage trends, usage thresholds, time-based features, location-based features, and user requests.

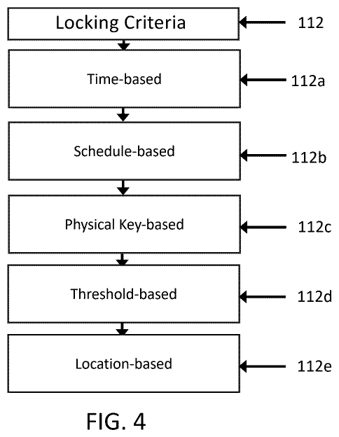

The locking module 110 implements one or more locking restrictions based on satisfaction of one or more locking criteria 112. In some embodiments, as shown for example in FIG. 4, the locking criteria 112 include time-based criteria 112a that prevents access at a specified time of day or day of week. In some embodiments, the locking criteria 112 include threshold-based criteria 112d that prevent access when a usage threshold is exceeded. For example, once the user has engaged with the electronic device 50 or a feature of the electronic device 50 for a specified amount of time, the user will no longer be able to access the device or those features for the remainder of the day, week, month, or year depending on the configured threshold period. In some embodiments, the locking criteria 112 include location-based criteria 112e that prevents access when the electronic device 50 is within a restricted geographic area. In some embodiments, the locking criteria 112 include schedule-based criteria 112b that prevents access according to a defined schedule combining time and day parameters. In some embodiments, the locking criteria 112 include physical key-based locking 112c that prevents access to the electronic device after engagement of a physical key.

In some embodiments, the locking restrictions define access limitations for mobile applications, websites, and electronic device functions when the specified locking criteria 112 have been satisfied. For example, the locking restrictions may include usage thresholds specifying maximum allowable usage time, permitted usage schedules specifying when access is allowed, and blocked content targets specifying which applications, websites, or device functions are restricted when the device is in the locked state 102.

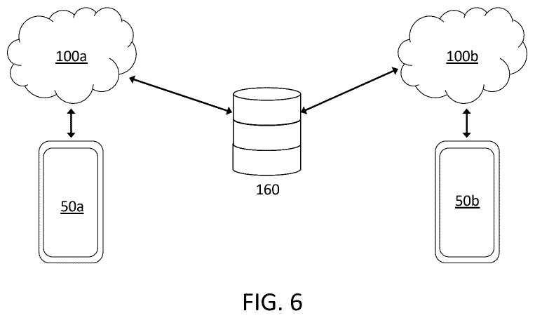

In some embodiments, as shown for example in FIG. 6, the locking module 110 is capable of multi-device locking based on a singular locking criterion. The locking module 110 will not only lock the electronic device 50 on which the locking criteria 112 was met, but will also lock any other electronic devices 50 paired with the mobile application 100 or connected via a shared network 160. For example, if a user's first electronic device 50 is their smartphone and the user exceeded their usage limit for that device 50, the locking module 110 will also lock their laptop, tablet, and/or gaming devices. Moreover, the locking module 110 is capable of locking electronic devices 50 that do not have NFC capabilities and therefore would be incompatible with direct physical key 200 engagement. Instead, the user may engage the physical key 200 with an NFC-compatible device 50 to subsequently lock or unlock all other electronic devices 50 that are connected via the shared network 160.

In some embodiments, the mobile application 100 includes a synchronization module configured to detect satisfaction of the one or more locking criteria 112 on a first electronic device 50 and propagate the locked state 102 to all other electronic devices 50 connected via the shared network 160. The synchronization module tracks cumulative usage data across the plurality of electronic devices 50 and can trigger the locked state 102 on all devices when an aggregate usage threshold is exceeded. In some embodiments, the synchronization module is configured to selectively propagate the locked state 102 to a subset of the electronic devices 50 based on device type or user-defined groupings.

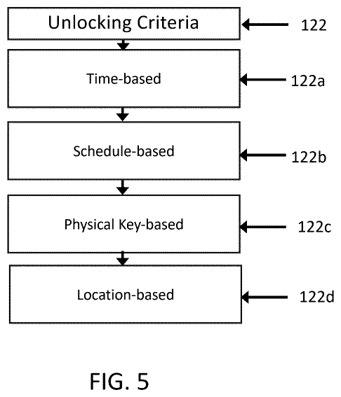

The unlocking module 120 communicates with the mobile application 100 to provide the user access to the electronic devices 50 or features within the electronic device 50. However, the unlocking module 120 only provides access after one or more unlocking criteria 122 are satisfied. In some embodiments, as shown for example in FIG. 5, the unlocking criteria 122 includes time-based criteria 122a such as the passage of a specified period of time or a schedule-based criteria 122b such as a specific time of day. In some embodiments, the unlocking criteria 122 includes location-based criteria 122d such as the electronic device 50 being located within a permitted geographic area. In some embodiments, the unlocking criteria 122 includes a physical key-based unlocking feature 122c, which unlocks the electronic device after engagement of the physical key 200 with the communication module 130. A person having ordinary skill in the art would understand that the unlocking module 120 may include any number of additional unlocking criteria 122 that permit access to the electronic device 50 or functions of the electronic device 50 upon completion or satisfaction of one or more unlocking criteria 122 that promote limited screen-time on the electronic device 50.

In some embodiments, the user may set the unlocking criteria 122. In some embodiments, the mobile application 100 customizes the unlocking criteria 122 to optimize performance. In some embodiments, a combination of approaches is utilized such that the user selects the preliminary unlocking criteria 122, and the mobile application 100 updates and customizes the criteria to optimize performance based on data collected by the data analytics and feedback module 150. For example, a user might initially set a timer-based unlocking criterion to unlock the electronic device 50 after 2 hours have passed. The mobile application 100 may then increase or decrease this time requirement based on the user's previous performance, time of day, and many more factors to provide an optimal solution for the user to minimize overall usage. In some embodiments, if the mobile application 100 determines that a user has been falling behind with their recommended thresholds, the application 100 may decrease the timing requirement to attempt to rebuild the habit. Conversely, if the mobile application 100 determines that a user has been successful with the current thresholds, the application 100 may increase the timing requirement to reinforce the newly created habit, thereby further reducing any unwanted screen time.

In order to unlock the electronic device 50 once the locking module 110 has transitioned the device to the locked state 102, the user may present the physical key 200 which provides an electronic communication to the communication module 130, which instructs the mobile application 100 to activate the unlocking module 120 and transition the device 50 from the locked state 102 to the unlocked state 104. Additionally, the user may satisfy one or more of the unlocking criteria 122 to transition the device to the unlocked state 104. Conversely, when the electronic device 50 is in the unlocked state 104, engagement of the physical key 200 with the communication module 130 instructs the mobile application 100 to activate the locking module 110 and transition the device 50 from the unlocked state 104 to the locked state 102. Additionally, upon satisfaction of one or more locking criteria 112, the device may transition from the unlocked state 104 to the locked state 102.

In some embodiments, the communication module 130 is configured to receive communications via Bluetooth, Wi-Fi, Near-Field Communication (NFC), infrared, and the like. In some embodiments, the physical key 200 may be embodied in various form factors, including but not limited to an NFC-enabled fob, a dedicated charging stand, a wearable tag, or a user-adjustable input device such as a knob or dial. In some embodiments, the physical key 200 is configured to communicate with the communication module 130 only when the physical key 200 is positioned within a near-field communication range of the electronic device 50, thereby requiring the user to be in physical proximity to the device 50 to change its state.

In some embodiments, the mobile application 100 includes a dual-module locking and unlocking structure comprising an access restriction module, a settings lock module, an access unlock module, and a settings unlock module. In this configuration, the access restriction module is configured to implement locking restrictions to prevent access to mobile applications, websites, and electronic device functions based on satisfaction of locking criteria 112. The settings lock module is configured to prevent modification of the locking restrictions and the locking criteria 112 themselves, thereby creating a settings lock that prevents the user from bypassing or altering the configured restrictions.

The settings lock module is activated upon engagement of the physical key 200 with the communication module 130 when configured in a settings lock mode. Once the settings lock module is active, the locking restrictions and locking criteria 112 remain immutable and cannot be modified until the physical key 200 is re-engaged to activate the settings unlock module, which permits modification of the locking restrictions and locking criteria 112. This ensures that the user cannot easily bypass or alter the restrictions during periods intended for focused, distraction-free work.

The access restriction module and the settings lock module operate independently such that the electronic device 50 can transition between the locked state 102 and the unlocked state 104 while the locking restrictions remain immutable. This independent operation creates multiple device states that provide varying levels of restriction and control.

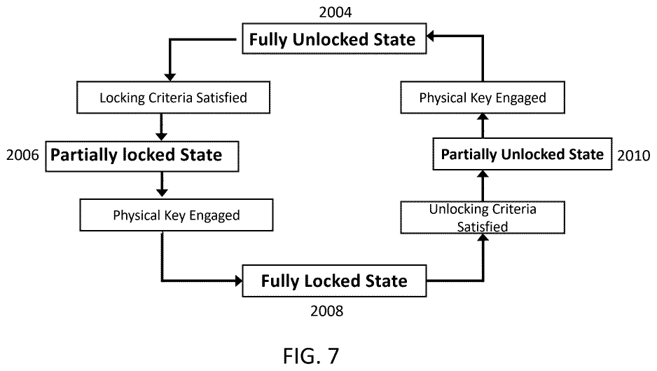

In embodiments utilizing the dual-module structure, as shown for example in FIG. 7, the mobile application 100 is configured to transition the electronic device 50 between four distinct states: a fully unlocked state 2004, a fully locked state 2008, a partially locked state 2006, and a partially unlocked state 2010.

In the partially locked state, the access restriction module is active and the settings lock module is inactive. In this state, the electronic device 50 has restricted access to device functions based on the locking restrictions, but the user is able to reconfigure the locking restrictions and the locking criteria 112 because the settings are not locked by the settings lock module.

In the fully locked state, both the access restriction module and the settings lock module are active. In this state, the electronic device 50 has restricted access to device functions based on the locking restrictions, and the user is unable to reconfigure the locking restrictions and the locking criteria 112 because the settings are locked by the settings lock module. This state provides maximum restriction and prevents bypass.

In the partially unlocked state, the access unlock module is active (granting access to device functions) but the settings lock module remains active (preventing settings modification). In this state, the electronic device 50 has access to device functions, but the user is unable to reconfigure the locking restrictions and the locking criteria 112. This state allows normal device usage while maintaining the integrity of the configured restrictions.

In the fully unlocked state, both the access unlock module and the settings unlock module are active. In this state, the electronic device 50 has access to device functions, and the user is able to reconfigure the locking restrictions and the locking criteria 112. This state provides maximum freedom and control over both device usage and settings configuration.

In the event that the electronic device 50 is in the locked state 102 and the user needs immediate access to the locked electronic device 50, the mobile application 100 includes a bypass mechanism known as the temporary access module 140. The temporary access module 140 can override the locking module 110 for a temporary period of time, such as an amount of time necessary to place an emergency phone call or send an SOS text message. In some embodiments, the user can select the length of time provided by the temporary access module 140. In some embodiments, the temporary access module 140 is activated by providing a specified emergency access code, thereby providing an additional layer of friction to prevent the user from constantly using the temporary access module 140 to regain access to the electronic device 50 in non-emergency situations. In some embodiments, the temporary access module 140 is activated upon engagement of the physical key 200 with the communication module 130 in a temporary access mode.

In some embodiments utilizing the dual-module structure, the temporary access module 140 overrides only the access restriction module and does not override the settings lock module. This means that during temporary access, the user can access mobile applications, websites, and device functions, but cannot modify the locking restrictions or locking criteria 112. After the temporary access period expires, the electronic device 50 automatically returns to the locked state 102.

The data analytics and feedback module 150 collects data regarding the user's daily, weekly, and monthly usage, current lock settings, trends, and other usage information to analyze and optimize the system's 1000 performance. In some embodiments, the data analytics and feedback module 150 includes machine learning, artificial intelligence, and language models to analyze the received data, optimize current locking criteria 112 and locking restrictions, and provide personalized recommendations to the user to promote the desired outcome of reduced screen time.

The data analytics and feedback module 150 provides feedback to the user based on collected data. In some embodiments, the module 150 provides feedback in the form of messages, additional friction points (electronic tasks to complete to regain access), and graphics of the user's performance. In some embodiments, the module 150 provides trends and streaks to the user to further help engagement and to promote a reduction in unwanted usage. In some embodiments, the module 150 provides motivational messages to encourage positive trends, progress reports that describe recent usage trends, and frictional messages which help prevent unwanted usage of the electronic device 50.

The data analytics and feedback module 150 may include a data collection feature for gathering usage data, a data analytics feature for analyzing and interpreting the data to optimize efficiency of the system 1000, a feedback feature for providing motivation and other forms of feedback to the user to promote continued usage of the system 1000, and a friction feature for providing an additional layer of friction to the user to further prevent any unwanted usage of the electronic device 50.

In some embodiments, the physical key 200 is a Near-Field Communication (NFC) device that can communicate with the mobile application 100 to toggle the device state between locked 102 and unlocked 104. In some embodiments, the physical key 200 may be configured such that upon engagement with the mobile application 100, the physical key 200 may selectively lock or unlock specific mobile applications, features, or websites within the electronic device 50, thereby targeting specific distractions and creating a focus mode. In some embodiments, the physical key 200 is a charging stand or object which is not typically carried by the user, thereby requiring the user to perform a certain action (e.g., walk up the stairs or go to a specific room in the house) in order to engage the physical key 200 and thereby change the device state.

In some embodiments, the physical key 200 is not limited to simply triggering a lock or unlock state transition; rather, it allows the user to customize key operational parameters. For example, the user may adjust the duration for which the device 50 remains locked (i.e., the length of the lock period) as well as the duration for which temporary access is granted by the temporary access module 140. These adjustable parameters can be communicated to the mobile application 100 via wireless protocols (e.g., Bluetooth or Wi-Fi) and synchronized across multiple electronic devices 50 connected via the shared network 160 to ensure consistent behavior across devices. This flexibility enables users to tailor the system 1000—for instance, setting a shorter unlock period during evenings to discourage prolonged usage and a longer unlock period in the morning to facilitate necessary tasks, thereby further promoting mindful device engagement and supporting focused work.

In some embodiments, the physical key 200 communicates usage data to the mobile application 100 at the time of authorization, allowing dynamic configuration of system behavior. In some embodiments, when authorizing post-limit overage (access granted after a usage threshold has been exceeded), the physical key 200 can communicate an overage amount that is permitted to the user to regain temporary access to the electronic device. For example, in some embodiments, the overage amount includes additional device time allowance such as +2 minutes, +5 minutes, +15 minutes. In some embodiments, the overage amount includes an additional number of permitted application launches. For example, a physical key 200 embodied as an adjustable dial or knob can be set to discrete positions corresponding to different overage budgets, and upon engagement with the communication module 130, transmits the selected overage parameters via Bluetooth or Wi-Fi to the mobile application 100. The mobile application 100 then enforces exactly the transmitted overage budget, against the available usage as it occurs and re-enforcing restrictions when the budget is exhausted or the overage window expires. In some embodiments, the physical key 200 can also communicate settings unlock duration parameters, specifying how long the restriction configuration parameters remain modifiable after authorization. These adjustable parameters can be synchronized across multiple electronic devices 50 connected via the shared network 160 to ensure consistent behavior across devices.

In some embodiments, the system 1000 includes a compliance monitoring mechanism configured to detect and deter bypass attempts on user devices. Because the mobile application 100 executes on personal electronic devices 50 that the user controls, the user could potentially disable the application, remove required operating system permissions, or uninstall the application entirely to circumvent the restrictions. To address this, the system 1000 implements a heartbeat compliance mechanism that periodically verifies proper operation and alerts designated contacts when noncompliance is detected.

In some embodiments, the electronic device 50 periodically transmits a compliance heartbeat to a remote server. The compliance heartbeat includes a compliance status vector comprising at least whether the mobile application 100 enforcement is currently active (active enforcement data), whether required operating system permissions or entitlements for enforcement are enabled (operating system permission data), and a timestamp of the last successful compliance determination (timestamp data). In some embodiments, the heartbeat is transmitted at regular intervals, such as every 15 minutes, 30 minutes, 1 hour, or other suitable interval.

In some embodiments, the system 1000 determines a noncompliant state when the compliance status indicates that required permissions have been disabled or a heartbeat has not been received for at least a threshold interval, thereby inferring that the mobile application 100 has been uninstalled, disabled, or otherwise rendered nonoperational. Upon detecting noncompliance, the system 1000 transmits an alert to at least one designated contact, such as an owner, partner, parent, administrator, or accountability partner. In some embodiments, the noncompliance status is also presented in a web-based dashboard or mobile application interface accessible to the designated contacts.

In some embodiments, authorization functions via the physical key 200 are conditioned on compliance status. When the electronic device 50 is in a noncompliant state, the system 1000 prevents the physical key 200 from authorizing: deactivation of the settings-lock mode (thereby preventing modification of locking criteria and locking restrictions), and/or granting of a bounded overage budget after usage threshold satisfaction. This conditional authorization ensures that users cannot disable enforcement mechanisms while retaining the ability to use the physical key 200 to circumvent restrictions. In some embodiments, once the electronic device 50 returns to a compliant state (required permissions re-enabled and heartbeat transmission resumed), the system 1000 requires a minimum compliance duration (e.g., 24 hours of continuous compliant operation) before re-enabling full physical key 200 authorization functionality. In some embodiments, the system 1000 implements an owner/member architecture for multi-user scenarios such as families, couples, or accountability partnerships. Restriction configuration parameters are associated with a group policy profile having an owner role and one or more member roles. Only the owner role is authorized to modify restriction configuration parameters via settings unlock; member role devices are prevented from modifying parameters even if a physical key 200 is available to the member.

In some embodiments, the owner device is also subject to the enforced restrictions. That is, the owner role is not merely an administrative console that configures restrictions for others; rather, the owner's own electronic device 50 is also restricted according to the same or similar restriction configuration parameters, promoting mutual accountability. In some embodiments, when a new electronic device 50 joins the group policy profile as a member device, the restriction configuration parameters automatically apply to that device without requiring manual configuration.

In some embodiments, compliance status and noncompliance alerts are shared among members of the group policy profile for social accountability. For example, if a member device enters a noncompliant state (e.g., by disabling required permissions), the owner and other designated members receive notifications. In some embodiments, the system 1000 can trigger financial accountability mechanisms upon defined noncompliance events, such as forfeiture of a financial stake or automatic charge when a device remains noncompliant beyond a threshold duration, as detected by telemetry (missing heartbeat beyond threshold, permissions disabled beyond threshold).

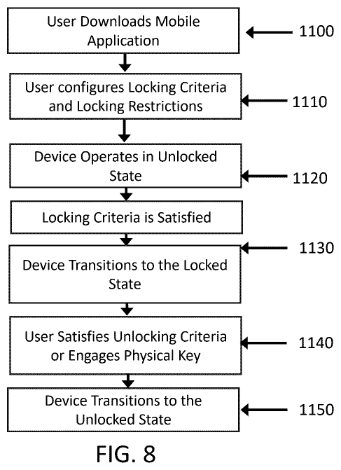

As shown for example in FIG. 8, an example use of the mobile application 100 to reduce unwanted usage of the electronic device 50 is shown and described. First, a user downloads the mobile application 100 onto their electronic device 50, 1100. Once downloaded and installed, the user configures the mobile application 100 to define one or more locking criteria 112 and locking restrictions through interacting with the locking module 110, 1110. In some embodiments, this includes selecting a specified schedule when the electronic device 50 is locked, a specified usage threshold that triggers the locked state 102, location-based restrictions, and whether engagement of the physical key 200 is required to unlock the device 50. Once configured, the user will have access to the electronic device 50 in the unlocked state 104 until one or more of the configured locking criteria 112 are satisfied, 1120. Once the locking criteria 112 are satisfied, the locking module 110 activates and the device 50 transitions from the unlocked state 104 to the locked state 102, 1130. Once in the locked state 102, the user will only regain access to the electronic device 50 or features within the electronic device 50 by satisfying one or more unlocking criteria 122 of the unlocking module 120, 1140. Lastly, upon satisfaction of one or more unlocking criteria 122, the device transitions from the locked state 102 to the unlocked state 104, 1150. For example, if the user configured a usage threshold of 4 hours and the user reached that threshold, the unlocking module 120 may require that a new day begins before unlocking the electronic device 50. Conversely, if the device 50 was locked by engagement of the physical key 200, the user can regain access to the electronic device 50 by re-engaging the physical key 200 with the mobile application 100, thereby activating the unlocking module 120 and transitioning the device 50 from the locked state 102 to the unlocked state 104.

In some embodiments, the locking criterion that triggered the locked state 102 does not have to match the unlocking criterion that triggers the unlocked state 104. For example, engagement of the physical key 200 may unlock the device 50 even if the daily usage threshold was exceeded. In some embodiments, the required unlocking method is determined by the data analytics and feedback module 150 based on data that determines the most effective unlocking method to promote minimal use of the electronic device 50.

As described above, in the event that the electronic device 50 is in the locked state 102 and the user needs immediate access to the locked device 50, the user may interact with the temporary access module 140 to regain temporary access to the electronic device 50. In some embodiments, the temporary access module 140 is activated upon engagement of the physical key 200 in a temporary access mode. In other embodiments, the user may enter an emergency access code to temporarily unlock the electronic device 50. In the event the device 50 was temporarily unlocked through the temporary access module 140, the device 50 will automatically transition back to the locked state 102 after a specified period of time or after an emergency communication (such as a phone call) has been completed on the electronic device 50.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. An electronic device screen-time limiting system comprising:
a mobile application executable on an electronic device, wherein the mobile application includes a locking module, an unlocking module, and a communication module; and wherein the mobile application is configured to transition the electronic device between a locked state, and an unlocked state;
a physical key configured to be in electronic communication with the communication module of the mobile application when the physical key is within a short-range wireless communication range of the electronic device;
wherein the locking module is configured to transition the electronic device into the locked state upon satisfaction of one or more locking criteria, and wherein the locked state implements one or more locking restrictions including restricted access to one or more applications, websites, and device functions;
wherein the locking module is further configured to operate in a settings-lock mode, wherein the settings-lock mode prevents modification of the one or more locking criteria, the one or more locking restrictions, and the one or more unlocking criteria;
wherein the settings-lock mode is activated upon engagement of the physical key with the communication module;
wherein while the settings-lock mode is active, the one or more locking criteria and the one or more locking restrictions remain immutable regardless of user input attempting to modify them;
wherein modification of the one or more locking criteria and the one or more locking restrictions is permitted only upon re-engagement of the physical key with the communication module to deactivate the settings-lock mode; and
wherein the unlocking module is configured to grant access to the electronic device based on satisfaction of one or more unlocking criteria, and wherein the unlocking module is configured to grant access to the electronic device upon engagement of the physical key with the communication module when the electronic device is in the locked state.

2. The electronic device screen-time limiting system of claim 1, wherein the one or more locking criteria are selected from the group consisting of: time of day, exceeding a usage threshold, and physical location of the electronic device.

3. The electronic device screen-time limiting system of claim 1, wherein the one or more unlocking criteria are selected from the group consisting of an expiration of a timer, a specific time of the day, and physical location of the electronic device.

4. The electronic device screen-time limiting system of claim 1, wherein the locking module comprises an access restriction module and a settings lock module, wherein the settings lock module prevents modification of the one or more locking criteria and the one or more locking restrictions, and wherein the access restriction module and the settings lock module operate independently such that the electronic device transitions between a fully locked state, a partially locked state, a partially unlocked state, and a fully unlocked state.

5. The electronic device screen-time limiting system of claim 1, further comprising a compliance monitoring mechanism configured to detect if the electronic device is in a compliant state or a noncompliant state, wherein the compliance monitoring mechanism is configured to cause the electronic device to periodically transmit a compliance heartbeat to a remote server, the compliance heartbeat including data selected from the group consisting of: active enforcement data, operating system permission data, and timestamp data; wherein the noncompliant state is determined when required operating system permissions are disabled or a compliance heartbeat has not been received for at least a threshold time interval; and wherein upon determining the noncompliant state, the compliance monitoring mechanism performs at least one of the following actions: transmits an alert to a designated contact, conditions physical key authorization on compliance restoration, and triggers a financial penalty.

6. An electronic device screen-time limiting system comprising:
a mobile application executable on one or more electronic devices, wherein the mobile application includes an access restriction module, a settings lock module, an access unlock module, a settings unlock module, and a communication module, and wherein the mobile application is configured to transition the one or more electronic devices between a fully locked state, a partially locked state, a partially unlocked state, and a fully unlocked state;
a physical key configured to be in electronic communication with the communication module of the mobile application when the physical key is within a short-range wireless communication range of one of the one or more electronic devices;
wherein the access restriction module is configured to implement one or more locking restrictions for the one or more electronic devices based on the satisfaction of one or more locking criteria, wherein the one or more locking restrictions define access limitations for mobile applications, websites, and electronic device functions;
wherein the one or more electronic devices are in the partially locked state when the access restriction module is active and wherein when in the partially locked state the one or more electronic devices may have restricted access to device functions but are able to reconfigure the one or more locking restrictions and the one or more locking criteria;
wherein the settings lock module is configured to prevent modification of the one or more locking restrictions, the one or more locking criteria, and the one or more unlocking criteria based on engagement of the physical key with the communication module;
wherein the one or more electronic devices are in the fully locked state when the access restriction module and settings lock module are active, and wherein when in the fully locked state, the one or more electronic devices have restricted access to device functions and are unable to reconfigure the one or more locking restrictions and the one or more locking criteria;
wherein the access unlock module is configured to grant access to the one or more electronic devices based on satisfaction of one or more unlocking criteria,
wherein the one or more electronic devices are in the partially unlocked state when the access unlock module is active and the settings lock module is active, wherein when in partially unlocked state, the one or more electronic devices have access to device functions but are unable to reconfigure the one or more locking restrictions and the one or more locking criteria;
wherein the settings unlock module is configured to permit modification of the one or more locking restrictions upon re-engagement of the physical key with the communication module;
wherein the one or more electronic devices are in the fully unlocked state when the access unlock module is active and the settings unlock module is active, wherein when in fully unlocked state, the one or more electronic devices have access to device functions and are able to reconfigure the one or more locking restrictions and the one or more locking criteria.

7. The electronic device screen-time limiting system of claim 6, wherein the one or more locking criteria are selected from the group consisting of a time-based criterion that prevents access at a specified time of day, a threshold-based criterion that prevents access when a usage threshold is exceeded, a location-based criterion that prevents access when the electronic device is within a restricted area, and a schedule-based criterion that prevents access according to a defined schedule.

8. The electronic device screen-time limiting system of claim 6, wherein the one or more unlocking criteria are selected from the group consisting of an expiration of a timer, a specified time of day, a location-based criterion that grants access when the electronic device is located within a permitted area, and engagement of the physical key with the communication module.

9. The electronic device screen-time limiting system of claim 6, further comprising:
a temporary access module configured to override the access restriction module to provide time-limited access to the mobile applications, websites, and device functions when the one or more electronic devices are in the fully locked state,
wherein the temporary access module does not override the settings lock module; and
wherein the temporary access module is activated upon at least one of: entry of a specified emergency code and engagement of the physical key with the communication module.

10. The electronic device screen-time limiting system of claim 6, further comprising a compliance monitoring mechanism configured to detect if the electronic device is in a compliant state or a noncompliant state, wherein the compliance monitoring mechanism is configured to cause the electronic device to periodically transmit a compliance heartbeat to a remote server, the compliance heartbeat including data selected from the group consisting of: active enforcement data, operating system permission data, and timestamp data; wherein the noncompliant state is determined when required operating system permissions are disabled or a compliance heartbeat has not been received for at least a threshold time interval; and wherein upon determining the noncompliant state, the compliance monitoring mechanism performs at least one of the following actions: transmits an alert to a designated contact, conditions physical key authorization on compliance restoration, and triggers a financial penalty.

11. An electronic device screen-time limiting system comprising:
a mobile application executable on an electronic device, wherein the mobile application includes a locking module and a communication module;
a physical key configured to communicate with the communication module when the physical key is in short-range wireless communication with the electronic device;
wherein the locking module is configured to track usage of the electronic device;
wherein the locking module is configured to determine when a usage threshold is satisfied and transition the electronic device into a post-limit state upon satisfaction of the usage threshold;
wherein in the post-limit state, the locking module implements one or more locking restrictions that prevent access to one or more applications, websites, or device functions;
wherein in the post-limit state, the locking module maintains the one or more locking restrictions unless an authorization signal is received from the physical key;
wherein upon receipt of the authorization signal from the physical key, the mobile application grants a bounded overage budget comprising at least one of additional usage time, a number of application launches, and a number of unlock events, wherein the bounded overage budget is available during an overage window;
wherein the mobile application is configured to monitor usage of the electronic device relative to the bounded overage budget as usage occurs during the overage window; and
wherein the locking module re-implements the one or more locking restrictions when the bounded overage budget is exhausted or the overage window expires.

12. The electronic device screen-time limiting system of claim 11, wherein the physical key communicates parameterization data to the mobile application at a time of authorization, the parameterization data specifying at least one of an overage amount and a duration of the overage window, and wherein the bounded overage budget is determined based on the parameterization data received from the physical key.

13. The electronic device screen-time limiting system of claim 11, wherein the physical key comprises a knob or dial having a plurality of discrete positions each corresponding to a different lock duration, and wherein engagement of the physical key causes the mobile application to enforce the locked state for the lock duration corresponding to a selected position.

14. The electronic device screen-time limiting system of claim 11, wherein the mobile application is further executable on a plurality of electronic devices and further includes an unlocking module and a synchronization module;
wherein the plurality of electronic devices are communicatively coupled through a shared network; and
wherein the synchronization module is configured to propagate the post-limit state to all of the plurality of electronic devices via the shared network.

15. The electronic device screen-time limiting system of claim 14, wherein the unlocking module on each of the plurality of electronic devices is configured to grant access based on satisfaction of one or more unlocking criteria, and wherein satisfaction of the one or more unlocking criteria on any one of the plurality of electronic devices propagates an unlocked state to all other electronic devices connected to the shared network.

16. The electronic device screen-time limiting system of claim 15, wherein engagement of the physical key with a first electronic device propagates an unlocked state to all of the devices within the plurality of electronic devices connected to the shared network.

17. The electronic device screen-time limiting system of claim 14, wherein the synchronization module is configured to selectively propagate the post-limit state to a subset of the plurality of electronic devices based on device type or user-defined groupings.

18. The electronic device screen-time limiting system of claim 14, wherein the synchronization module is configured to propagate the post-limit state to any electronic devices within the plurality of electronic devices that lack short-range wireless communication capability.

19. The electronic device screen-time limiting system of claim 14, wherein the synchronization module includes a local unlock mode, wherein the local unlock mode requires engagement of a physical key with one of the plurality of electronic devices, and upon engagement, the engaged electronic device unlocks without propagating the unlocked state to other devices.

20. The electronic device screen-time limiting system of claim 14, wherein the usage threshold and bounded overage budget are associated with a group policy profile comprising an owner role and one or more member roles, wherein only an electronic device associated with the owner role is authorized to configure the usage threshold and bounded overage budget parameters and to authorize granting of the bounded overage budget via the physical key, and wherein electronic devices associated with the one or more member roles cannot modify these parameters or authorize overage.
